(19) United States
(12) Patent Application Publication
(10) Pub. No.: US 2013/0052510 A1
(43) Pub. Date: Feb. 28, 2013

(54) NON-AQUEOUS ELECTROLYTE SECONDARY-CELL BATTERY AND MANUFACTURING METHOD

(71) Applicants: Shinya Miyazaki, Naruto-shi (JP); Naoko Tsunomura, Sumoto-shi (JP)

(72) Inventors: Shinya Miyazaki, Naruto-shi (JP); Naoko Tsunomura, Sumoto-shi (JP)

(73) Assignee: SANYO ELECTRIC CO., LTD., Osaka (JP)

(21) Appl. No.: 13/595,061

(22) Filed: Aug. 27, 2012

(30) Foreign Application Priority Data
Aug. 29, 2011 (JP) 2011-186156

(51) Int. Cl. H01M 10/02; H01M 10/04

(52) U.S. Cl. 429/156; 429/162; 29/623.2

(57) ABSTRACT

To improve cycling characteristics by evening out the battery reaction across different areas of a laminated electrode assembly in a non-aqueous electrolyte secondary-cell battery where the laminated electrode assembly, having tape applied to a top layer, an end face, and a bottom layer thereof, is contained in an outer casing, the tape applied to the periphery of the laminated electrode assembly, configured from a stacked plurality of interleaved separators, cathode plates, and anode plates, extends in the stacking direction across the top layer, end face, and bottom layer of the laminated electrode assembly. Each piece of tape is formed of a base material that is one of styrene-butadiene rubber, styrene rubber, or butadiene rubber.

### CROSS REFERENCE TO RELATED APPLICATION

The disclosure of Japanese Patent Application No. 2011-186156, filed Aug. 29, 2011, including the description, drawings, and claims thereof, is incorporated herein by reference in its entirety.

### TECHNICAL FIELD

The present invention pertains to a non-aqueous electrolyte secondary-cell battery in which a laminated electrode assembly having cathode plates and anode plates interleaved with separators is contained within a casing along with a non-aqueous electrolyte solution.

### BACKGROUND ART

Non-aqueous electrolyte secondary-cell batteries, such as lithium-ion batteries, are used as power sources in portable devices such as mobile phones, notebook computers, and PDAs, and also as power sources in robots, electric vehicles, and the like.

In a lithium-ion battery, the electrode plates are such that cathode plates and anode plates are wound into a spiral with separators therebetween, or are such that quadrilateral electrodes are layered in plurality. The outer casings are, for example, laminated outer casings manufactured by welding laminated film.

For layered electrodes, sheet-like cathode plates having cathode current collector tabs and similarly sheet-like anode plates having anode current collector tabs are interleaved with a necessary quantity of separators. Tape is applied to the outer faces of the outermost electrode plates in the layered stack, so as to reach across the plate end faces and fix the relative positions of the electrodes.

Patent Literature 1 and 2 describe examples of a rigid or stretchable film used as the base material for adhesive tape, such as polyethylene terephthalate, polyphenylene sulfide, polypropylene, polystyrene, polycarbonate, and polymethyl methacrylate.

Patent Literature 3 describe examples of base materials for adhesive tape, such as a vinylidene fluoride-hexafluoropropylene copolymer, an acrylonitrile-methyl acrylate copolymer, polyurethane, polyethylene, and polytetrafluoroethylene.

### CITATION LIST

### Patent Literature

### [Patent Literature 1]

Japanese Patent Application Publication No. H11-102722

### [Patent Literature 2]

Japanese Patent Application Publication No. H11-121044

### [Patent Literature 3]

Japanese Patent Application Publication No. 2003-151634

### SUMMARY OF INVENTION

### Technical Problem

As described above, when tape is made to adhere to the laminated electrode assembly so as to reach from the top face to the bottom face of the layered stack, the layered stack becomes correspondingly thicker in the areas where the tape is located. As such, when the electrode plates expand during the charge cycle, the pressure applied by the outer casing to the laminated electrode assembly is greater in such areas, relative to areas where the tape is not located.

Accordingly, pressure is applied unevenly across areas, leading to an uneven battery reaction that, in turn, diminishes battery efficiency by affecting cycling characteristics.

Battery efficiency is especially prone to diminution when such a non-aqueous electrolyte secondary-cell battery is contained in a case and configured as a battery pack.

Although such problems are more common when laminated outer casings are used, the swelling and contraction of the electrodes during charging and discharging also leads to pressure on the laminated electrode assembly from the casing when the casing is a canister. This causes an uneven distribution of pressure.

In consideration of the above-described problem, the present invention aims to improve cycling characteristics by evening out the battery reaction across different areas of the laminated electrode assembly in a non-aqueous electrolyte secondary-cell battery where the laminated electrode assembly, having tape applied to a top layer, an end face, and a bottom layer, is contained in an outer casing.

### Solution to Problem

In order to achieve the above-described aim, the non-aqueous electrolyte secondary-cell battery pertaining to the present invention comprises an outer casing that contains therein a laminated electrode assembly and a non-aqueous electrode solution, the laminated electrode assembly being an interleaved stack of a cathode plate, an anode plate, and a separator, wherein an adhesive layer adheres to a surface of the laminated electrode assembly so as to extend across a top face, an end face, and a bottom face thereof, and the adhesive layer is made from at least one rubber selected from the group consisting of styrene-butadiene rubber, styrene rubber, and butadiene rubber.

Also, a manufacturing method for the non-aqueous electrolyte secondary-cell battery pertaining to the present invention comprises an electrode assembly fabrication step of interleaving and stacking a cathode plate, an anode plate, and a separator to fabricate a laminated electrode assembly; an adhesion step of applying tape, at least one rubber selected from the group consisting of styrene-butadiene rubber, styrene rubber, and butadiene rubber being used as a base material for the tape, such that the tape adheres to a surface of the laminated electrode assembly so as to extend across a top face, an end face, and a bottom face thereof; an electrode assembly insertion step of inserting the electrode assembly and introducing an electrolyte solution into an outer casing; and a sealing step of sealing the outer casing having the electrode assembly therein.

The electrolyte solution may also be polymerized, once the electrolyte solution has been inserted during the electrode assembly insertion step.

### Advantageous Effects of Invention

The non-aqueous electrolyte secondary-cell battery pertaining to the present invention and the non-aqueous electrolyte secondary-cell battery manufactured according to the present manufacturing method each include a laminated electrode assembly having an adhesive layer that adheres to a surface thereof so as to extend across a top face, an end face, and a bottom face, and the adhesive layer is made from at least one rubber selected from the group consisting of styrene-butadiene rubber, styrene rubber, and butadiene rubber which, upon contact with the non-aqueous electrolyte solution, proceeds to gelatinize.

Accordingly, upon gelatinization, the adhesive layer becomes thinner due to pressure applied thereto by the outer casing. Thus, pressure is applied evenly without excessive pressure being applied to the area to which the adhesive layer adheres.

Accordingly, the battery reaction occurs evenly throughout all areas, suppressing battery efficiency diminution.

Also, the gelatinized adhesive layer remains between the surface of the laminated electrode assembly and the outer casing at the location of adhesion, thus fixing the electrodes plates in position relative to the outer casing. As such, the electrode plates and the separators are prevented from shifting.

Such effects are most remarkable when the non-aqueous electrolyte is a non-aqueous electrolyte solution. However, the effects are also achievable with polymer electrolytes.

An outer casing formed from laminated film is generally more likely to apply pressure to the laminated electrode assembly at locations where the adhesive layer adheres. However, applying the above-described invention decreases this pressure, thus increasing the achievable effect.

Further, having the outer casing formed from laminated film be sealed shut so as to have a low-pressure interior is useful for improving the cycling and power output characteristics in relation to the constitutional pressure on the laminated electrode assembly. Conversely, this approach is prone to applying pressure to the location of adhesion. Given that such pressure can be reduced through the application of the above-described invention, a non-aqueous electrolyte secondary-cell battery having superb cycling and power output characteristics is achievable.

The adhesive layer is easily made from tape in which at least one rubber selected from the group consisting of styrene-butadiene rubber, styrene rubber, and butadiene rubber is used as a base material, and the tape has an adhesive material applied to the base material so as to easily adhere to the laminated electrode assembly.

An acrylate ester copolymer is preferably used as the adhesive material for its balance of heat, weather, and solvent resistance.

Also, by having the tape adhere to the laminated electrode assembly at multiple locations, reliable prevention of shifting by the electrode plates and the separators is made possible.

Further, although a battery pack configured using non-aqueous electrolyte secondary-cell batteries in which the outer casing is formed of laminated film is prone to applying pressure to the laminated electrode assembly at the tape adhesion locations, the pressure on the laminated electrode assembly can be evened out by using non-aqueous electrolyte secondary-cell batteries to which the present invention has been applied.

### BRIEF DESCRIPTION OF DRAWINGS

FIG. 1 illustrates the external appearance of a non-aqueous electrolyte secondary-cell battery 1.

FIG. 2 is a perspective view illustrating the configuration of a laminated electrode assembly 10.

FIG. 3 is an exploded view illustrating the configuration of the laminated electrode assembly 10.

FIG. 4A is a cross-sectional diagram of the laminated electrode assembly 10, FIG. 4B is a cross-sectional diagram of the non-aqueous electrolyte secondary-cell battery 1, and FIG. 4C is a cross-sectional diagram of a non-aqueous electrolyte secondary-cell battery pertaining to a contrasting example, each cross-section being taken along a top edge.

### DESCRIPTION OF EMBODIMENTS

A non-aqueous electrolyte secondary-cell battery pertaining to the present invention is described below using an example of a square lithium-ion battery as an Embodiment. However, the present invention is not limited to the following Embodiment. Many variations thereof are also realizable, provided that such modification do not exceed the scope here disclosed.

### (Structure of Non-Aqueous Electrolyte Secondary-Cell Battery 1)

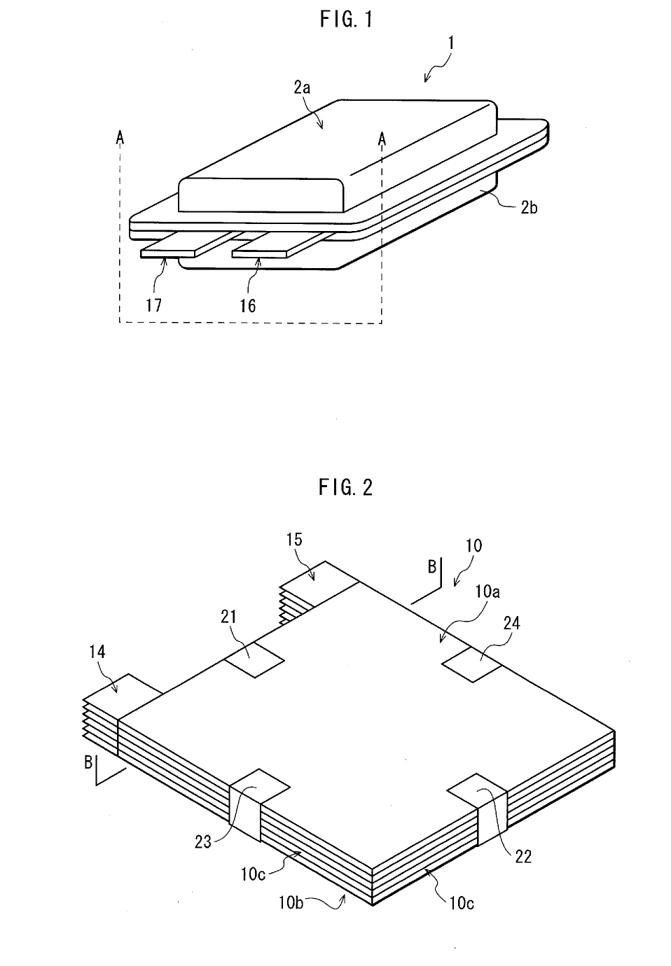

FIG. 1 illustrates the external appearance of a non-aqueous electrolyte secondary-cell battery 1.

The non-aqueous electrolyte secondary-cell battery 1 is configured such that laminated outer casings 2a and 2b contain therein a laminated electrode assembly 10 and a non-aqueous electrolyte solution.

As shown in FIG. 1, the laminated outer casings 2a and 2b are formed from a pair of laminated film pieces, each having a storage recess formed therein, and having peripheral portions that are welded together. The storage recess forms a space containing the laminated electrode assembly 10 within. The laminated outer casings 2a and 2b each have a laminate structure in which resin layers are layered on both sides of a piece of aluminium foil.

The laminated outer casings 2a and 2b may also be structured such that the storage recess is provided in only one of the laminated outer casings, while no storage recess is provided in the other. Further, a pair of laminated film pieces is not necessarily required. The laminated outer casings may also be structured such that a single laminated film piece is folded over in half.

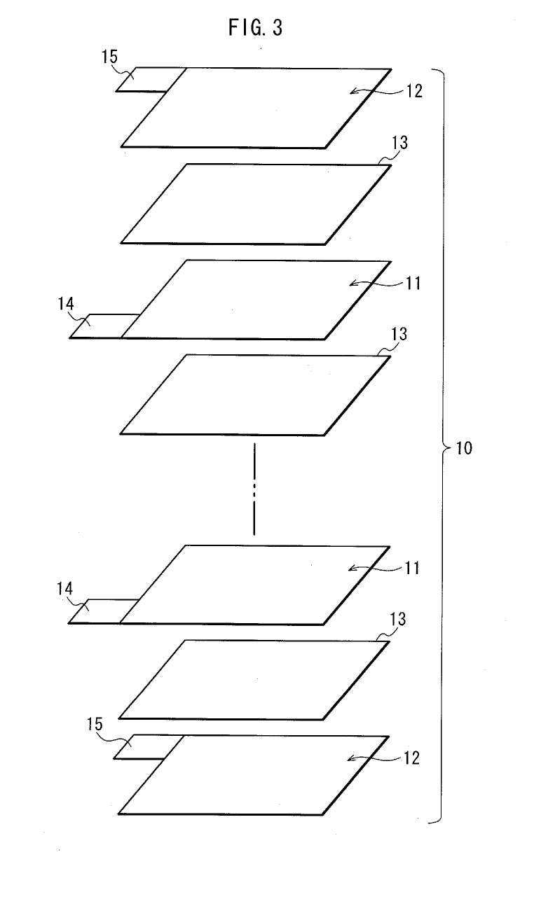

As shown in FIG. 3, the laminated electrode assembly 10 includes cathode plates 11 and anode plates 12, stacked in plurality with separators 13 disposed therebetween.

The anode plates 12 are provided in a quantity that is greater than the quantity of cathode plates 11 by one. One of the anode plates 12 is arranged at the outermost side of the laminated electrode assembly 10.

A cathode current collector terminal 16 (0.5 mm in thickness), made from an aluminium plate, and an anode current collector 17 (0.5 mm in thickness), made from a copper plate, protrude from the above-described laminated outer casings 2a and 2b so as to pass through the joined areas of the peripheral portions.

Each of the cathode plates 11 is structured such that a conductive core for use as a cathode, made from a quadrilateral of aluminium foil, has a cathode active material layer, made from a combination of a cathode active material, a binding agent, and a conductive material, provided on one or both sides thereof.

The cathode active material may be, for example, LiCoO₂, LiNiO₂, LiMn₂O₄, or a compound thereof.

A cathode current collector tab 14 is formed from the upper edge of each cathode plate 11 so as to be made integral with the conductive core used as the cathode and protrude therefrom. No cathode active material layer is provided on the cathode current collector tabs 14.

The cathode current collector tabs 14 are overlaid and bonded as a group to both sides of the cathode current collector terminal 16.

Each of the anode plates 12 is structured such that a conductive core for use as an anode, made from a quadrilateral of copper foil, has an anode active material layer, made from a combination of an anode active material and a binding agent, provided on one or both sides thereof.

The anode active material may be natural or artificial graphite, for example.

An anode current collector tab 15 is formed from the upper edge of each anode plate 12 so as to be made integral with the conductive core used as the cathode and protrude therefrom.

Each of the separators 13 is a microporous membrane made of polyethylene (PE) or of polypropylene (PP).

The cathode current collector tabs 14 are overlaid and bonded as a group to both sides of the cathode current collector terminal 16. Similarly, the anode current collector tabs 15 are overlaid and bonded as a group to both sides of the anode current collector terminal 16.

The cathode current collector terminal 16 is formed from an aluminium plate and the anode current collector 17 is formed from a copper plate. However, each of the terminals may also be formed from a nickel plate.

The non-aqueous electrolyte solution is a solution in which supporting electrolytes are dissolved in a non-aqueous solvent.

The non-aqueous solvent is beneficially a solvent in which any of ethylene carbonate (EC), diethyl carbonate (DEC), propylene carbonate (PC), γ-butyrolactone (GBL), methyl ethyl carbonate (MEC), dimethyl carbonate (DMC), and similar carbonate solvents. A solvent in which cyclic carbonates and chain carbonates are combined is particularly beneficial.

Examples of supporting salts include LiBF₄, LiPF₆, LiN(SO₂CF₃)₂, LiN(SO₂C₂F₅)₂, LiPF₆₋ₓ(CnF₂ₙ₋₁)ₓ, (where 1<x<6, n=1 or 2) and the like.

(Tape)

As shown in FIG. 2, pieces of tape 21-24 are affixed to the outside of the laminated electrode assembly 10 so as to extend along the stacking direction of the laminated electrode assembly 10. That is, the pieces of tape 21-24 are affixed to a top layer 10a, an end face 10c, and a bottom layer 10b of the laminated electrode assembly 10. The top layer 10a is an outer face of one of the outermost electrode plates with respect to the stacking direction, the bottom layer 10b is an outer face of another one of the outermost electrode plates with respect to the stacking direction, and the end face 10c is a plurality of electrode plate edges, stacked together.

The tape 21-24 is formed of a base material that is one of styrene-butadiene rubber, styrene rubber, or butadiene rubber.

The tape 21-24 can easily be made to adhere to the laminated electrode assembly 10 by applying adhesive to a surface of the base material so as to form a layer of adhesive paste on the base material of the tape 21-24. However, the adhesive need not be applied to the base material. In such circumstances, welding or the like may be applied to the base material. No restriction to the type of adhesive is intended, though representative examples include acrylics, silicones, and rubbers.

The tape may be made to adhere to the laminated electrode assembly 10 at a single location. However, to securely fasten together the electrode plates making up the laminated electrode assembly 10, having tape adhere to multiple locations on the laminated electrode assembly 10 is preferable. As indicated in FIG. 2, having tape adhere to locations respectively corresponding to each of the four sides (i.e., to the top, bottom, left, and right side) of the laminated electrode assembly 10 is particularly beneficial.

(Effects of Non-Aqueous Electrolyte Secondary-Cell Battery 1)

The non-aqueous electrolyte secondary-cell battery 1 of the above-described Embodiment is structured such that of the laminated electrode assembly 10 has pieces of tape 21-24 adhering to the surface thereof across the top layer 10a, the end face 10c, and the bottom layer 10b, the pieces of tape 21-24 being made from one more materials selected from styrene-butadiene rubber, styrene rubber, and butadiene rubber as base material or an adhesive layer applied thereto.

The pieces of tape 21-24 are preferably formed from a tape material that is styrene-butadiene rubber, styrene rubber, butadiene rubber, or a compound in which two or more of these are combined. However, when an adhesive layer is added to a thin base material, the adhesive layer of such a piece of tape 21-24 may also be formed from styrene-butadiene rubber, styrene rubber, butadiene rubber, or a compound in which two or more of these are combined.

Styrene-butadiene rubber, styrene rubber, and butadiene rubber are materials prone to gelatinization upon contact with a non-aqueous electrolyte solution. As such, the pieces of tape 21-24, being made of these materials or of a compound thereof, gelatinize within the non-aqueous electrolyte secondary-cell battery 1 and become adhesive layers 21-24 adhering to the surface of the laminated electrode assembly 10.

The adhesive layers 21-24, in which gelatinization has progressed, easily deform and become thinner when the outer casings 2a and 2b are pressurized. As such, the pressure applied to the areas where the adhesive layers 21-24 adhere is not excessive. Accordingly, pressure is evenly applied across the entirety of the laminated electrode assembly 10.

Thus, the battery reaction proceeds evenly throughout the entire laminated electrode assembly 10, leading to improved battery efficiency.

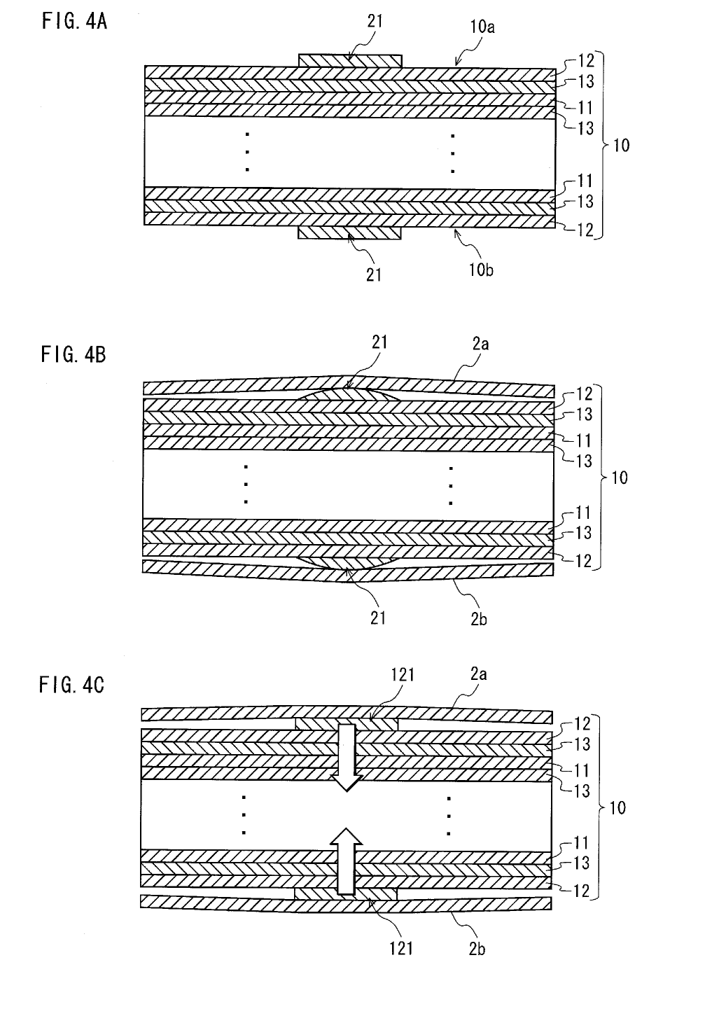

This point is elaborated upon with reference to FIGS. 4A through 4C.

FIGS. 4A and 4B illustrate the non-aqueous electrolyte secondary-cell battery 1 pertaining to the present Embodiment. FIG. 4A is a schematic diagram showing a cross-section of the laminated electrode assembly 10, with the pieces of tape 21-24 adhering thereto, taken along line B-B of FIG. 2. FIG. 4B is a schematic diagram showing a cross-section of the non-aqueous electrolyte secondary-cell battery 1 taken along line A-A of FIG. 1.

Before coming into contact with the non-aqueous electrolyte solution, the piece of tape 21 adhering to the laminated electrode assembly 10 retains the original shape thereof as indicated in FIG. 4A. However, when the laminated electrode assembly 10 is held within the outer casings 2a and 2b along with the non-aqueous electrolyte solution, the piece of tape 21 undergoes gelatinization and, as shown in FIG. 4B, becomes the adhesive layer 21 adhering to the surface of the laminated electrode assembly 10.

The outer casings 2a and 2b are formed from laminated film pieces, which is a useful approach for improving the cycling and power output characteristics when applying compositional pressure to the laminated electrode assembly 10.

Also, despite pressure being applied by the outer casings 2a and 2b to the adhesive layer 21, in which gelatinization has occurred, excessive pressure is not applied at the location of the adhesive layer 21. That is, pressure is applied evenly across the entirety of the laminated electrode assembly 10, and thus, the battery reaction occurs evenly, realizing excellent cycling and power output characteristics for the non-aqueous electrolyte secondary-cell battery.

Further, the adhesive layer 21, in which gelatinization has occurred, remains at the location of adhesion on the laminated electrode assembly 10 and prevents the electrode plates 11 and 12 and the separators 13 from shifting. Particularly, the adhesive layers 21-24 adhere to the laminated electrode assembly 10 at multiple locations, enabling reliable prevention of shifting by the electrode plates 11 and 12 and the separators 13.

FIG. 4C is a cross-sectional diagram of a non-aqueous electrolyte secondary-cell battery used as a contrasting example.

The contrasting example is configured similarly to the non-aqueous electrolyte secondary-cell battery 1 pertaining to the present Embodiment, differing only in that the tape is made from a base material that is PP or PE.

The non-aqueous electrolyte secondary-cell battery of the contrasting example has pieces of tape made from a base material of PP or PP adhering to the laminated electrode assembly 10. Thus, the pieces of tape maintain their shape despite contact with the non-aqueous electrolyte solution. As a result, the positions on the laminated electrode assembly 10 where the pieces of tape 121 adhere protrude in the stacking direction.

Also, the outer casings, made from laminated film, are sealed shut with a low-pressure interior. Thus, as indicated by the white arrows in FIG. 4C, extreme pressure is applied to the locations of adhesion by the outer casings 2a and 2b, such that the battery reaction in the laminated electrode assembly 10 is prone to becoming uneven.

In a non-aqueous electrolyte secondary-cell battery pertaining to conventional technology, some types of tape adhering to the laminated electrode assembly are made from a base material that undergoes swelling upon contact with a non-aqueous electrolyte solution. However, given that tape made from such a base material maintains the original shape thereof without undergoing gelatinization, the effect of evening the pressure applied to the laminated electrode assembly is weaker in contrast to the non-aqueous electrolyte secondary-cell battery pertaining to the present Embodiment, in which the tape used is made from a base material that is styrene-butadiene rubber, styrene rubber, or butadiene rubber.

### Embodiment

The following describes an Embodiment of a manufacturing method for the non-aqueous electrolyte secondary-cell battery 1.

### (Cathode Plate 11 Manufacture)

A cathode slurry is prepared by combining Li(Ni_{1/3}O_{1/3}Mn_{1/3})O₂, used as the cathode active material, at 94 wt %, carbon powder, used as the electrolyte, at 3 wt %, and polyvinylidene fluoride, used as the binding agent, at 3 wt %, then combining the whole with N-methyl-2-pyrrolidone, used as the solvent.

The resulting slurry is then applied to both sides of a conductive core used as the cathode, which is made from aluminium foil (20 μm in thickness), using a doctor blade method. Subsequently, after drying and compression with a milling roller, the conductive core used as the cathode is cut into a predetermined shape to produce a cathode plate 11 having a cathode current collector tab 14.

The dimensions of the cathode plate 11 are, for example, 145 mm in width by 150 mm in height, while the dimensions of the cathode current collector tab 14 are, for example, 30 mm in width by 20 mm in height.

### (Anode Plate 12 Manufacture)

A slurry is prepared by combining graphite powder, used as the anode active material, at 95 wt %, a binding agent (carboxymethyl cellulose and styrene-butadiene) at 5 wt %, and water.

Afterword, the slurry is applied to both sides of a conductive core used as the anode, which is made from copper foil (10 μm in thickness), using a doctor blade method. Subsequently, after drying and compression with a milling roller, cutting is performed to produce an anode plate 12 having a predetermined shape.

The dimensions of the anode plate 12 are, for example, 150 mm in width by 155 mm in height, while the dimensions of the anode current collector tab 12 are, for example, 30 mm in width by 20 mm in height.

### (Laminated Electrode Assembly 10 Manufacture)

The laminated electrode assembly 10 is manufactured by interleaving 20 of the cathode plates 11 and 21 of the anode plates 12 in alternation with the separators 13. One of the anode plates 12 is disposed at each of the outermost faces (i.e., the top and bottom faces with respect to the stacking direction) of the laminated electrode assembly 10.

The dimensions of the separators 13 are 150 mm in height, 155 mm in width, and 20 μm in thickness, thus equal to that of the anode plates 12.

Next, the pieces of tape 21-24 are made to adhere to the laminated electrode assembly 10 at four locations, one corresponding to each of the four edges thereof.

The pieces of tape 21-24 are formed from a base material that is styrene-butadiene rubber and is 20 μm in thickness. The adhesive layer is an acrylate ester copolymer having butyl acrylate as a main component and being 10 μm in thickness.

The pieces of tape 21-24 are made to adhere to the laminated electrode assembly 10 such that piece of tape 21 is at the top edge, piece of tape 22 is at the bottom edge, piece of tape 23 is at the left edge, and piece of tape 24 is at the right edge. All pieces of tape 21-24 extend from the top layer 10a, across the end face 10c, and reach the bottom layer 10b.

Each of the pieces of tape 21-24 has an adhesive layer and thus easily adheres to the laminated electrode assembly 10. The cathode plates 11, the anode plates 12, and the separators 13 are fixed in place by having the pieces of tape 21-24 adhere thereto.

The cathode current collector tabs 14 protruding from the laminated electrode assembly 10 are welded to the cathode current collector terminal 16 using ultrasonic welding, and the anode current collector tabs 15 protruding from the laminated electrode assembly 10 are similarly welded to the anode current collector terminal 17 using ultrasonic welding. Subsequently, the laminated electrode assembly 10 is disposed in the space within the laminated outer casings 2a and 2b.

(Assembly of Non-Aqueous Electrolyte Secondary-Cell Battery 1)

Afterwards, three of the four edges of the laminated outer casings 2a and 2b are welded shut, such that the cathode current collector terminal 16 and the anode current collector 17 protrude from the top edge of the laminated outer casings 2a and 2b.

The non-aqueous electrolyte solution is then poured in through the remaining open edge of the laminated outer casings. The non-aqueous electrolyte solution may be, for example, an electrolyte compound of ethylene carbonate (ED) and methyl ethyl carbonate (MEC) are combined at a 30:70 ratio by volume, and dissolved in LiPF₆ at a concentration of 1 M (i.e., 1 mole per litre).

The remaining unwelded edge of the laminated outer casings is then welded shut such that low-pressure conditions occur within. Accordingly, the non-aqueous electrolyte secondary-cell battery 1 is produced.

(Cycle Test)

A cycle test was performed on the non-aqueous electrolyte secondary-cell battery pertaining to the present invention and manufactured using the above-described method (where the base material for tape is styrene-butadiene rubber and the adhesive material is an acrylate ester copolymer), using a non-aqueous electrolyte secondary-cell battery pertaining to a first contrasting example, in which the base material for the tape is PP and the adhesive material is an acrylate ester copolymer, and a non-aqueous electrolyte secondary-cell battery pertaining to a second contrasting example where the base material for the tape is PE and the adhesive material is also an acrylate ester copolymer.

The non-aqueous electrolyte secondary-cell batteries pertaining to the Embodiment and to each of the contrasting examples differ in terms of the base material used for the tape, but are otherwise configured identically.

Cycle Test Method:

Each battery was charged in a 25° C. environment with constant current (of 1 C, final voltage of 4.2 V) and constant voltage (of 4.2 V, final current of 1/50 C), then discharged at a rate of 2 C, down to 2.5 V. Taking the above to define one charge cycle, 200 such charge cycles were performed. A charge maintenance ratio (%), which is the ratio of the charge capacity at cycle 200 to the charge capacity at cycle 1, was then measured for each battery.

The charge maintenance ratios so measured are as given in Table 1.

TABLE 1

| | Charge Maintenance Ratio at |
|---|---|
| | Cycle 200 |
| Embodiment | 98% |
| Contrasting Example 1 | 95% |
| Contrasting Example 2 | 95% |

The non-aqueous electrolyte secondary-cell battery pertaining to the Embodiment had a higher charge maintenance ratio than the non-aqueous electrolyte secondary-cell batteries pertaining to the two contrasting examples.

The non-aqueous electrolyte secondary-cell batteries pertaining to the contrasting examples had uneven battery response during the charge cycle due to the high pressure applied in the areas where the pieces of tape adhere, whereas the non-aqueous electrolyte secondary-cell battery pertaining to the Embodiment did not have such pressure during the discharge cycle due to the gelatinization undergone by the pieces of tape upon contact with the non-aqueous electrolyte solution. Also, tension decreased in the non-aqueous electrolyte secondary-cell battery pertaining to the Embodiment due to the swelling of the laminated electrode assembly during charging and discharging, caused by the gelatinization of the tape upon contact with the non-aqueous electrolyte solution.

(Applicability to Battery Packs)

The above-described non-aqueous electrolyte secondary-cell battery 1 may be configured as a battery pack by arranging a plurality of assemblies within the outer casings.

High pressure is applied to each of a plurality of non-aqueous electrolyte secondary-cell batteries in order to bundle multiple non-aqueous electrolyte secondary-cell batteries into a battery pack. As such, the positions on the laminated electrode assembly 10 where the tape adheres are prone to pressure applied by the outer casings 2a and 2b.

According to the present invention, the pressure applied to the laminated electrode assembly 10 is evened out, thus avoiding uneven response. Accordingly, the present invention is more effective for application to a non-aqueous electrolyte secondary-cell battery configured as a battery pack.

(Other Remarks)

The above-described Embodiment uses a non-aqueous electrolyte solution as the non-aqueous electrolyte. However, the same effects are also obtainable by using a polymer electrolyte as the non-aqueous electrolyte. However, the effects are stronger when a non-aqueous electrolyte solution is used.

The above Embodiment describes a non-aqueous electrolyte secondary-cell battery in which the outer casing is formed from laminated film. However, the effects of the present invention are also achievable in a non-aqueous electrolyte secondary-cell battery in which the outer casing is made of metal, provided that tape made from one of styrene-butadiene rubber, styrene rubber, and butadiene rubber is made to adhere to the top layer, end face, and bottom layer of the laminated electrode assembly. However, the effects are stronger when applied to the non-aqueous electrolyte secondary-cell battery of the present invention, having an outer casing made of laminated film.

### INDUSTRIAL APPLICABILITY

The present invention is applicable to a non-aqueous electrolyte secondary-cell battery used as a power source for portable devices, a robot, a drive source for an electric vehicle, a back-up power source, and so on.

### REFERENCE SIGNS LIST

1 Non-aqueous electrolyte secondary cell battery
2a, 2b Laminated outer casings
10 Laminated electrode assembly
10a Top layer
10b Bottom layer
10c End face
11 Cathode plates
12 Anode plates
13 Separators
14 Cathode current collector tabs
15 Anode current collector tabs
16 Cathode current collector terminal
17 Anode current collector terminal
21-24 Tape (Adhesive layer)

1. A non-aqueous electrolyte secondary-cell battery comprising an outer casing that contains therein a laminated electrode assembly and a non-aqueous electrode solution, the laminated electrode assembly being an interleaved stack of a cathode plate, an anode plate, and a separator, wherein
an adhesive layer adheres to a surface of the laminated electrode assembly so as to extend across a top face, an end face, and a bottom face thereof, and
the adhesive layer is made from at least one rubber selected from the group consisting of styrene-butadiene rubber, styrene rubber, and butadiene rubber.

2. The non-aqueous electrolyte secondary-cell battery of claim 1, wherein
the outer casing is formed of laminated film.

3. The non-aqueous electrolyte secondary-cell battery of claim 1, wherein
the outer casing is sealed shut so as to have a reduced-pressure interior.

4. The non-aqueous electrolyte secondary-cell battery of claim 1, wherein
the adhesive layer is made from tape, at least one rubber selected from the group consisting of styrene-butadiene rubber, styrene rubber, and butadiene rubber being used as a base material for the tape.

5. The non-aqueous electrolyte secondary-cell battery of claim 4, wherein
the tape has an adhesive material applied to the base material.

6. The non-aqueous electrolyte secondary-cell battery of claim 5, wherein
the adhesive material is made from an acrylate ester copolymer.

7. The non-aqueous electrolyte secondary-cell battery of claim 1, wherein
the adhesive layer is provided as a plurality of pieces adhering to the laminated electrode assembly at a plurality of locations.

8. A battery pack comprising a plurality of non-aqueous electrolyte secondary-cell batteries according to claim 2.

9. A manufacturing method for a non-aqueous electrolyte secondary-cell battery, comprising:
an electrode assembly fabrication step of interleaving and stacking a cathode plate, an anode plate, and a separator to fabricate a laminated electrode assembly;
an adhesion step of applying tape, at least one rubber selected from the group consisting of styrene-butadiene rubber, styrene rubber, and butadiene rubber being used as a base material for the tape, such that the tape adheres to a surface of the laminated electrode assembly so as to extend across a top face, an end face, and a bottom face thereof;
an electrode assembly insertion step of inserting the electrode assembly and introducing an electrolyte solution into an outer casing; and
a sealing step of sealing the outer casing having the electrode assembly therein.

10. The manufacturing method for a non-aqueous electrolyte secondary-cell battery of claim 9, wherein
the outer casing used in the sealing step is formed of laminated film.

11. The manufacturing method for a non-aqueous electrolyte secondary-cell battery of claim 10, wherein
during the sealing step, the outer casing is sealed shut so as to have a reduced-pressure interior.

12. The manufacturing method for a non-aqueous electrolyte secondary-cell battery of claim 9, wherein
the tape used in the adhesion step has an adhesive material applied to one side of the base material.

13. The manufacturing method for a non-aqueous electrolyte secondary-cell battery of claim 12, wherein
the adhesive material is made from an acrylate ester copolymer.

14. The manufacturing method for a non-aqueous electrolyte secondary-cell battery of claim 9, wherein
during the adhesion step, a plurality of pieces of the tape are applied so as to adhere to the laminated electrode assembly at a plurality of locations.

15. A battery pack comprising a plurality of non-aqueous electrolyte secondary-cell batteries manufactured according to the manufacturing method of claim 10.
